(19) United States
(12) Patent Application Publication
(10) Pub. No.: US 2014/0234800 A1
(43) Pub. Date: Aug. 21, 2014

(54) ANCHORING ELEMENT AND METHOD

(71) Applicant: Zvi Laster, Poriya Elite (IL)

(72) Inventor: Zvi Laster, Poriya Elite (IL)

(73) Assignee: CORTEX DENTAL IMPLANTS INDUSTRIES, LTD., Shlomi (IL)

(21) Appl. No.: 14/263,791

(22) Filed: Apr. 28, 2014

Related U.S. Application Data
(63) Continuation-in-part of application No. 13/137,265, filed on Aug. 2, 2011, now abandoned.
(60) Provisional application No. 61/401,697, filed on Aug. 18, 2010.

(51) Int. Cl. A61C 8/00

(52) U.S. Cl. CPC A61C 8/0022
USPC 433/174

(57) ABSTRACT

An anchoring element for use in bone, with an external and an internal wall. The external wall has externally threaded peripheral surface facilitating the embedding of the anchoring element within the bone, and the internal wall has an internal peripheral surface that, taken together with the externally threaded peripheral surface, define an annular wall around a hollow central portion and around a longitudinal axis. At least one non-radial slot passes through the externally threaded peripheral surface, the annular wall, and the internal peripheral surface, such that at least one pointed fluke is defined at a juncture of the non-radial slot and the outer peripheral surface for cutting the bone and directing bone fragments into said hollow central portion, wherein the at least one pointed fluke extends from a fluke leading face to a fluke trailing face, and wherein the fluke leading face is skewed relatively to said fluke trailing face.

### CROSS-REFERENCE TO RELATED APPLICATIONS

This application is a continuation-in-part application of U.S. patent application Ser. No. 13/137,265 filed Aug. 2, 2011, and claiming priority from U.S. Provisional Patent Application Ser. No. 61/401,697, filed Aug. 18, 2010, titled “Anchoring Element and Method”.

### FIELD OF THE INVENTION

The present invention generally relates to anchoring elements designed to be used in a variety of dental, medical, and surgical procedures where it is desired to embed a mechanical attachment into living bone.

### BACKGROUND OF THE INVENTION

Various different methods or techniques are known for securing dental prostheses with a patient's oral cavity. One illustrative example of a procedure that uses anchoring elements may be dental prostheses using embedded anchoring elements. However, the exemplary embodiments, and the description and drawings disclosing the same, should be interpreted by way of illustrative purposes only without limiting the scope of the present invention disclosure. Other types of procedures may well be considered as applicable for the utilization of the presently disclosed anchoring elements.

More particularly, dental anchoring elements may provide a desirable prosthesis for patients who are missing one or more natural teeth. A dental anchoring element may include an anchoring element that may be embedded into the jawbone and a prosthetic tooth that is attached to and supported by the anchoring element. The prosthetic tooth may be attached directly to the anchoring element or an abutment fixture may be attached to the anchoring element and support the prosthetic tooth in turn. An appropriate anchoring element will support bone growth that invades the anchoring element such that the anchoring element becomes integrated with the surrounding bone in a process termed osseointegration. However, other types of anchoring elements, designed to be embedded and/or integrated with living bone tissue, may also be included in the scope of the present disclosure.

An anchoring element for supporting a prosthetic tooth may be embedded in what is termed a two-stage procedure. In the first stage, the anchoring element is embedded into the jawbone and the surgical site is then closed. After a period of several months the anchoring element will achieve osseointegration. The site of the anchoring element is then re-opened surgically to allow the attachment of a prosthetic tooth.

Other techniques may be employed to permit a dental anchoring element to be embedded in a one-stage procedure. In a one-stage procedure, the anchoring element is embedded and a prosthetic tooth is immediately fitted thereto. The immediately fitted prosthetic tooth may be an interim prosthesis that allows the soft tissue to properly heal and maintains the spacing and alignment of adjacent teeth during the period of osseointegration. A permanent prosthetic tooth may be fitted at a later date after at least some osseointegration has occurred, generally without requiring an additional surgical procedure.

To achieve successful osseointegration it is desirable that the anchoring element fit closely into the surrounding bone. It is also be desirable that the anchoring element does not move relative to the surrounding bone during the period of osseointegration. Where the anchoring element cannot be closely fitted to the surrounding bone, it may be necessary to use bone-grafting materials to fill the space between the anchoring element and the surrounding bone.

Molars are commonly missing teeth. However, many times, the use of an anchoring element to replace a molar may present some special difficulties, as molars may generally have multiple roots. The mandibular molars of the lower jaw generally have two roots. The maxillary molars of the upper jaw generally have three roots. In a fresh extraction site, the void left by the molar roots presents a site that can be difficult to fit with an anchoring element. In addition, the bone in the molar region of the jaw may generally consist of a thin, hard layer of cortical bone surrounding a core of softer, spongy, cancellous bone. The cancellous bone may provide a lesser, or an even poorer support, for the anchoring element.

As molars may generally be relatively large teeth, it may be desirable to use an anchoring element having a relatively large diameter to fill the void following an extraction. However, the use of a wide anchoring element may require that a significant amount of bone be removed from the extraction site to accommodate the anchoring element. This may leave only a small amount of cortical bone available to support the anchoring element which may be embedded in predominantly cancellous bone. In particular, the use of a wide anchoring element may require the removal of a triangular mound-shaped mass of bone that is found between the roots and is known as the interradicular bone. Thus, it may prove difficult to place an anchoring element in a fresh molar extraction site with sufficient stability to allow the embedding of the dental anchoring element.

An option sometime practiced during the anchoring procedure of molars is called or referred to as “asymmetric loading”. In asymmetric loading, an anchoring element may be implanted in only one of the two (in the case of a mandibular molar extraction) or three (in the case of a maxillary molar extraction) root voids that remain post extraction. Such optional asymmetric loading may lead to reduced stability, which may lead to undesirable osseointegration and/or reduced strength and/or stability of the anchoring element.

Another circumstance that can present difficulties in placing an anchoring element within a patient's mouth may occur in cases where it is desired to place a dental prosthesis into a healed extraction site. When a molar is lost, the alveolar ridge that supports the teeth may be fairly rapidly re-absorbed. This may lead to a loss of height of the jawbone in the area of tooth loss. When an anchoring element is to be embedded into a healed extraction site, it may not be possible to insert the anchoring element to a desirably large depth.

In the lower jaw, the presence of the mandibular alveolar nerve in the lower jaw may limit the depth to which the anchoring element can be inserted. In the upper jaw, the maxillary sinus may likewise limit the depth to which the anchoring element can be inserted. These limiting anatomical features may require the use of a short anchoring element, the use of which for such cases may result in a lower rate of long-term success because of the reduced surface area available for osseointegration.

It would be desirable to have an anchoring element that can be used to place a dental anchoring element into the molar area both for fresh extraction sites and for healed sites, as well as an associated method therefore, which may facilitate the above. This may be attained with the subject matter in accordance with the following.

### SUMMARY OF THE INVENTION

In the following disclosure, aspects thereof are described and illustrated in conjunction with systems and methods which are meant to be exemplary and illustrative, not limiting in scope. In various embodiments, one or more of the above-described issues and/or desirable effects have been addressed, while other aspects are directed to affect other advantages or improvements.

According to one aspect of the present disclosure, an anchoring element for use in bone is provided, the anchoring element having a distal end and an apical end.

Preferably, the anchoring element to which the present disclosure relates may comprise an anchoring element body having a longitudinal axis ζ defining an apical-to-distal direction and a threading in direction Tᵢ.

Furthermore, the anchoring element comprises an external wall having externally threaded peripheral surface facilitating the embedding of said anchoring element within the bone, an internal wall having an internal peripheral surface that, taken together with said externally threaded peripheral surface, define an annular wall around a hollow central portion and around a longitudinal axis ζ, and at least one non-radial slot passing through said externally threaded peripheral surface of said external wall, said annular wall, and said internal peripheral surface of said internal wall, such that at least one pointed fluke is defined at a juncture of said non-radial slot and said outer peripheral surface for cutting the bone and directing bone fragments into said hollow central portion, wherein said at least one pointed fluke extends from a fluke leading face to a fluke trailing face, and wherein said fluke leading face is skewed relatively to said fluke trailing face.

In some embodiments, threads of the externally threaded outer peripheral surface are self-threading.

In some embodiments, the internal peripheral surface of said anchoring element is threaded.

In some embodiments, the external wall has a conical shape.

In some embodiments, the hollow central portion has a conical shape.

In some embodiments, the hollow central portion further comprises a cylindrical portion.

In some embodiments, the external threading on the conical portion has a different pitch than the pitch of the external threading of the cylindrical section.

In some embodiments, the at least one pointed fluke curves circumferentially and radially inwardly.

In some embodiments, the fluke leading face defines a fluke outer leading edge as the fluke leading face meets the outer peripheral surface, and a fluke inner leading edge as the fluke leading face meets the inner peripheral surface, while the fluke trailing face defines a fluke outer trailing edge as the fluke trailing edge meets the outer peripheral surface and a fluke inner trailing edge as the fluke trailing face meets the inner peripheral surface.

In some embodiments, the fluke leading face extends between the fluke outer leading edge and the fluke inner leading edge, and wherein the fluke trailing face extends between the fluke outer trailing edge and the fluke inner trailing edge.

In some embodiments, the fluke leading face is angled at a leading angle λ relative to a tangent T_{λ} with respect to the outer peripheral surface at the fluke outer leading edge.

In some embodiments, the fluke trailing face is angled at a trailing angle θ relative to a tangent T_{θ} with respect to the outer peripheral surface at the fluke outer trailing edge.

In some embodiments, at least one of the leading angle λ and the trailing angle θ is constant.

In some embodiments, at least one of the leading angle λ and the trailing angle θ varies along an axial extent E of the at least one non-radial slot.

In some embodiments, the leading angle λ is acute.

In some embodiments, the leading angle λ is in the range between 30° and 55° degrees.

In some embodiments, the trailing angle θ is obtuse.

In some embodiments, the ratio between the leading angle λ and trailing angle θ is in the range between 0.2 and 0.4.

In some embodiments, a normal v_{λ} to the fluke leading face at the fluke outer leading edge is directed generally inwardly towards the longitudinal axis ζ.

In some embodiments, a normal v_{λ} to the fluke leading face at the fluke outer leading edge is directed generally outwardly away from the longitudinal axis ζ.

According to another aspect, the anchoring element comprises an external wall having a conical shape with externally threaded peripheral surface facilitating the embedding of the anchoring element within the bone, and an internal wall having an internal peripheral surface that, taken together with the externally threaded peripheral surface, define an annular wall around a conical hollow central portion, wherein said hollow central portion further comprises a cylindrical portion.

In some embodiments, the external threading on the conical portion has a different pitch than the pitch of the external threading of the cylindrical section.

Yet another aspect of the present disclosure comprises a method for placing an anchoring element into the oral cavity which is intended to receive an attachment to a bone, comprising: providing the anchoring element described above, further comprising a locating recess with internal threading, providing an abutment having a hollow structure with internal threading, providing a screw having a bottom portion with external threading corresponding to the internal threading of the abutment, and further corresponding to the internal threading of the locating recess, providing a drilling tool having an annular drilling element with a cutting section and a plurality of indexing lines, providing a milling tool having an annular milling element with a conical shape and external threading with an upper surface edge and a single indexing line corresponding to the plurality of indexing lines of the annular drilling element, drilling with the cutting section of the drilling tool, to a predetermined depth until a predetermined indexing line aligns with the bone surface, milling and creating a conical thread with the external threading of the milling tool to a predetermined depth until the single indexing line aligns with the bone surface, trimming bone chips with the upper surface edge of the annular milling element, rotating the anchoring element and inserting into the bone, such that the threading of the anchoring element engages the bone, attaching the abutment to the anchoring element, and inserting the screw to engage the internal threading of the abutment and of the anchoring element.

In some embodiments, the annular drilling element further has at least one window.

In some embodiments, the annular milling element further has at least one indentation.

In addition to the exemplary aspects and embodiments described above, further aspects and embodiments will become apparent by reference to the following detailed description and drawings.

### BRIEF DESCRIPTION OF THE DRAWINGS

Exemplary embodiments are illustrated in referenced drawing figures. It is intended that the embodiments and figures disclosed herein are to be considered illustrative rather than restrictive. It is emphasized that, according to common practice, the various features of the drawing are not to scale, but rather dimensions of various features are arbitrarily expanded or reduced for clarity.

Reference will now be made to the accompanying drawings, in which:

FIG. 1 is a perspective view of the apical end of a first exemplary anchoring element for use within bone, according to an exemplary embodiment.

FIG. 2 is a perspective view of the distal end of the first anchoring element shown in FIG. 1.

FIG. 3 is a cross-sectional view of the first anchoring element shown in FIG. 1.

FIG. 4 is a perspective view of the apical end of a second exemplary anchoring element for use within bone, according to an exemplary embodiment.

FIG. 5 is a perspective view of the distal end of the second anchoring element shown in FIG. 4.

FIG. 6 is a top plan view of the apical end of the second anchoring element shown in FIG. 5.

FIG. 7 is a perspective view of the apical end of a third exemplary anchoring element for use within bone, according to an exemplary embodiment.

FIG. 8 is a perspective view of the distal end of the third anchoring element shown in FIG. 7.

FIG. 9 is a top plan view of the apical end of the third anchoring element shown in FIG. 7.

FIG. 10A is a bottom view of a further exemplary embodiment of a fourth anchoring element.

FIG. 10B is an enlarged segment of the fourth anchoring element shown in FIG. 10A.

FIG. 11A is a bottom view of a further exemplary embodiment of the fourth anchoring element having four slots.

FIG. 11B is a bottom view of a further exemplary embodiment of the fourth anchoring element having only one slot.

FIG. 12 is a frontal view of a drilling tool.

FIG. 13A is a frontal view of a milling tool.

FIG. 13B is a cross-sectional view of the milling tool.

FIG. 13C is a bottom view of the milling tool.

FIG. 14 is a cross-sectional view of the groove created in the bone after drilling and milling procedures.

FIG. 15 is a further exemplary embodiment of a fifth anchoring element.

FIG. 16A is a cross-sectional view of the fifth anchoring element.

FIG. 16B is a bottom view of the fifth anchoring element.

FIG. 17A is an isometric view of an abutment.

FIG. 17B is a bottom isometric view of the abutment.

FIG. 18A is an isometric view of a screw.

FIG. 18B is a cross-sectional view of the screw.

FIG. 19A is an isometric view of a first rotation key.

FIG. 19B is an isometric view of a second rotation key.

FIG. 20A is an assembled view of the fifth anchoring element, the abutment, and the screw prior to inserting the screw into the fifth anchoring element.

FIG. 20B is an assembled view of the fifth anchoring element, the abutment, and the screw after inserting the screw into the fifth anchoring element.

FIG. 21A is an exploded view of the fifth anchoring element, and the healing cap.

FIG. 21B is an assembled view of the fifth anchoring element, and the healing cap.

### DETAILED DESCRIPTION OF THE INVENTION

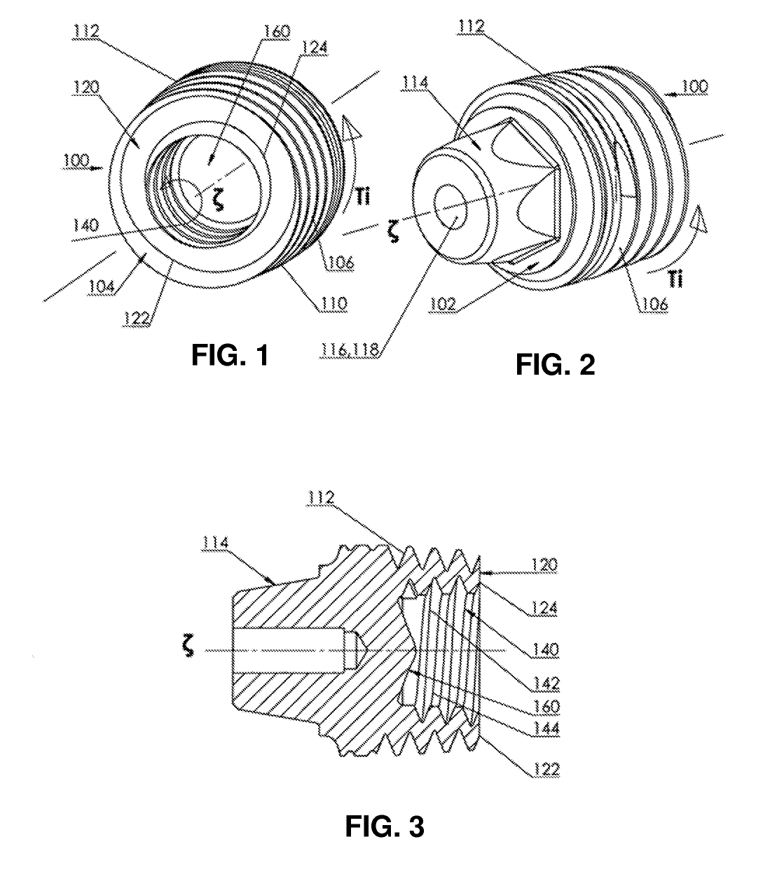

Attention is firstly drawn to FIGS. 1 to 3. For convenience of description, a first anchoring element 100 will be described with reference to a distal end 102 and an apical end 104. The apical end 104 is shown in FIG. 1 (as the end to the lower left of the drawing), and is the end that is embedded to the greatest depth into a bone (not shown). The distal end 102 is shown in FIG. 2 (as the end to the lower left of the drawing), and is the end that may be exposed when the first anchoring element 100 is embedded within the bone (not shown), as well as the end to which an attachment (not shown) may be connected with the first anchoring element 100 either integrally therewith and/or removably therefrom. The first anchoring element 100 extends from the distal end 102 to the apical end 104 along a longitudinal axis ζ, defining a circumferential threading in direction Tᵢ.

The first anchoring element 100 may include a first surface 106 that comprises a generally cylindrical exterior surface of the anchoring element, as an external wall. The term “generally cylindrical” is used to describe a surface that is substantially rotationally symmetric about the longitudinal axis ζ. The first surface 106 may include a screw thread. It will be appreciated that a screw thread is not rotationally symmetric in the strictest sense; however a screw thread or any similar feature is intended to be included by the term “substantially rotationally symmetric”. The exterior surface of the first anchoring element 100 may include various features such as the aforementioned screw thread and other features such as shoulders, tapered portions, rings, ridges and the like (all not shown), all of which are intended to be included by the term “generally cylindrical”.

At least a portion of the first surface 106 of the first anchoring element 100 may include a peripheral first external thread 112 having a pitch. The first external thread 112 may be of any of a variety of forms known or discovered to be effective for embedding the anchoring element within a bone. Furthermore, the first external thread 112 may include one or more thread starts (not shown). The first external thread 112 may include self-threading (thread cutting) features or other features that may aid in embedding the first anchoring element 100 into bone, and/or that may promote osseointegration.

The first surface 106 may include a frustrated first conical portion 110 adjacent to the apical end 104 of the first anchoring element 100 such that a smaller circumference (not shown) of the first conical portion 110 is adjacent the apical end 104. The first conical portion 110 may facilitate placing the first anchoring element 100 into a cavity (not shown) that may be prepared within the bone (not shown) or, alternatively, to receive the first anchoring element 100. Alternatively, the first conical portion 110 may facilitate insertion of the first anchoring element 100 without preparing a cavity within the bone, so that the first anchoring element 100 may self-prepare a cavity in which it is to be inserted. The first conical portion 110 may provide a somewhat smaller leading apical end that allows the first anchoring element 100 to initially engage the bone with minimal force and align the anchoring element with respect to the cavity that has been prepared in the bone, or within the cavity that the first anchoring element 100 self-prepares.

FIG. 2, in particular, may illustrate an exemplary abutment surface 114 that may be provided to receive a dental prosthesis. The exemplary abutment surface 114 may include a wrenching surface or structure that provides a suitable surface to effectively be gripped by a tool for embedding the first anchoring element 100. Various known or discovered wrenching structures may be employed. The exemplary abutment surface 114 may further include a locating recess 116 and an optional internal anchoring thread 118 to receive devices (not shown) that may be coupled to the first anchoring element 100 by a screw (not shown) and/or other appropriate coupling means.

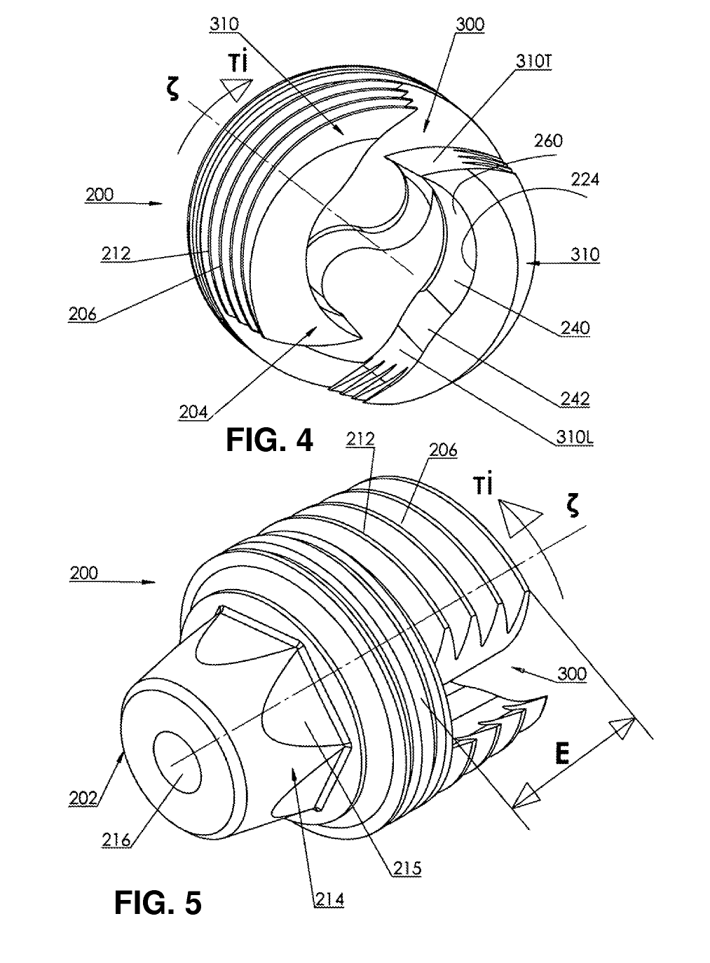

The first anchoring element 100 may include an annular second surface 120 disposed toward the apical end 104 of the first surface 106 and joined thereto along an outer circumference 122 of the second surface 120. The second surface 120 may engage the bottom (not shown) of the cavity (not shown) that may have been prepared within the bone (not shown) and thereby contribute significantly to the stability of the first anchoring element 100 embedded therein. The second surface 120 may be substantially flat or may have a rounded shape or other configuration chosen to effectively cooperate with the bottom of the cavity that has been prepared within the bone, or that the first anchoring element 100 self-prepared during insertion. As may be seen in FIGS. 1 and 3, the first anchoring element 100 may include a peripheral third surface 140, as an internal wall, concentric with the first surface 106 and joined to the second surface 120 along an inner circumference 124 of the second surface 120. The third surface 140 may extend away from the apical end 104 or from the second surface 120 generally distally, to an inner fourth surface 160. The first surface 106 together with the third surface 140 may define an annular wall around a hollow central portion and around the longitudinal axis ζ.

At least a portion of the third surface 140 may include a third internal structure 142 which may be of any of a variety of forms known or discovered to be effective for embedding the anchoring element within the bone, such as screw threads and other structures such as shoulders, tapered portions, rings, ridges, corrugations and the like (only a screw thread is shown), all of which are intended to aid in embedding the first anchoring element 100 into the bone, or to promote osseointegration. The third internal structure 142 may include self-cutting, such as, but not limited to, self-threading (thread cutting) structures or other elements or components that may aid in embedding the first anchoring element 100 into the bone, or that promote osseointegration.

It is contemplated that the cavity (not shown) within the bone (not shown) that is prepared to receive the first anchoring element 100, or the cavity (not shown) which the first anchoring element 100 self-prepares during insertion, may leave a residual, upstanding core of bone (not shown) such that the third surface 140 will at least partially abut and/or engage the upstanding core so as to provide additional initial stability and/or an additional surface for osseointegration.

The third surface 140 may include a frusto-conical second portion 144 such that a larger circumference C of the second conical portion 144 is adjacent the apical end 104. The second frusto-conical portion 144 may facilitate the insertion of the first anchoring element 100 into that portion of the cavity (not shown) that includes the up-standing core (not shown). The second frusto-conical portion 144 and/or the internal thread 142 formed thereon may thread into and/or compress the upstanding core (not shown) of the residual bone, as the first anchoring element 100 is being embedded, so as to further increase the initial stability, resist pulling, and/or enhance the bending resistance of the first anchoring element 100.

FIGS. 4 through 6 illustrate a second exemplary embodiment of an anchoring element 200 that also illustrates the principles and teachings of the present disclosure. The second anchoring element 200 may include many features that are similar to those of the first anchoring element 100 illustrated by FIGS. 1 through 3. Similar features for the second anchoring element 200 have been given reference numerals that are similar to the reference numerals used for the first anchoring element 100 as increased by 100. For convenience in description, the second anchoring element 200 will be described with reference to a distal end 202 and an apical end 204. The apical end 204 is shown in FIG. 4 (as the end to the lower left of the drawing), and is the end that is embedded to the greatest depth in bone. The distal end 202 may be best seen in FIG. 5 (as the end to the lower left of the drawing), and is the end that may be exposed when the second anchoring element 200 is embedded within the bone, as well as the end to which an attachment (not shown) may be connected to the anchoring element 200 either integrally therewith and/or removably therefrom. The second anchoring element 200 extends from the distal end 202 to the apical end 204 along the longitudinal axis ζ, defining a circumferential threading in direction Tᵢ.

The second anchoring element 200 includes a first surface 206 that is a generally cylindrical exterior surface of the anchoring element, as an external wall. Limitations related to the term “generally cylindrical” as used above also apply to the second anchoring element 200. At least a portion of the first surface 206 of the second anchoring element 200 includes a peripheral first external thread 212 having a pitch. The first external thread 212 may be of any of a variety of forms known or discovered to be effective for embedding the anchoring element within the bone. The first external thread 212 may include self-threading (thread cutting) structures or other elements or components that aid in the embedding of the second anchoring element 200 into the bone, or that promote osseointegration.

As may be best seen in FIG. 5, the second anchoring element 200 may include an abutment surface 214 disposed toward the distal end of the first surface 206.

The abutment surface 214 may be of any of a variety of known or discovered forms that permit attachment to the second anchoring element 200. In this embodiment, the second anchoring element 200 includes an abutment surface 214 which is in the form of a frusto-conical pyramid having flats 215 formed on its flukes. The flats 215 formed upon the abutment surface 214 may provide wrenching surfaces. If the anchoring element is used to support a dental prosthesis, a prosthetic tooth may be directly coupled to the abutment surface 214 such as by a cement of any suitable type and/or other suitable adhesives. Alternatively, the abutment surface 214 may further include a locating recess 216 and an internal anchoring thread (not shown) to receive a device (not shown) that may be coupled to the second anchoring element 200 by a screw (not shown).

The second anchoring element 200 includes an annular second surface 220 disposed toward the apical end 204 of the first surface 206 and joined thereto along an outer circumference 222 of the second surface 220. The second surface 220 may engage the bottom (not shown) of a cavity (not shown) that may have been prepared in the bone (not shown) and thereby contribute significantly to the stability of the second anchoring element 200 embedded therein. The second surface 220 may be substantially flat or may have a rounded shape or other configuration chosen to effectively cooperate with the bottom of the cavity that has been prepared within the bone.

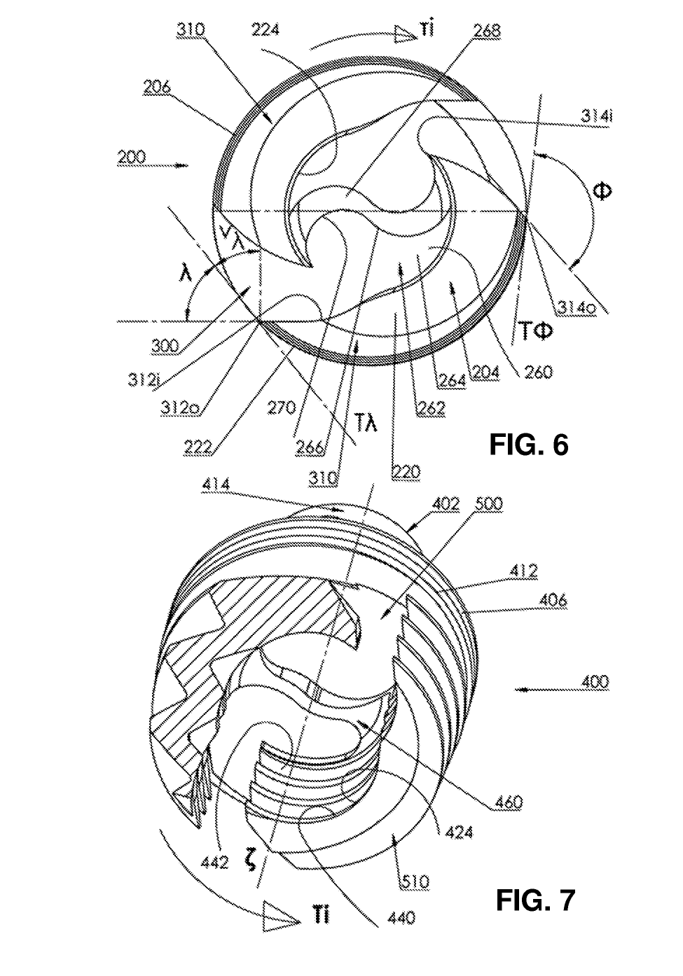

As may be seen in FIGS. 4 and 6, the second anchoring element 200 includes a peripheral third surface 240, as an internal wall, generally concentric with the first surface 206 and joined to the second surface 220 along an inner circumference 224 of the second surface 220. The third surface 240 may extend away from the apical end 204 or from the second surface 220 to an inner fourth surface 260. While the third surface 240 is shown as a smooth surface, at least a portion of the third surface 240 may include a third internal structure 242 which may be any one of a variety of forms known or discovered to be effective for embedding the anchoring element within the bone, such as screw threads and/or other elements or components such as, but not limited to, shoulders, tapered portions, rings, ridges, corrugations and the like (not shown), all of which are intended to aid in the embedding of the second anchoring element 200 into bone, or to promote osseointegration. The third internal structure 242 may include self-cutting structures, such as, but not limited to, self-threading (thread cutting) structures or other elements or components that may aid in the embedding of the anchoring element 200 into the bone, or that promote osseointegration. The first surface 206 together with the third surface 240 may define an annular wall defined around a hollow central portion and around the longitudinal axis ζ.

It is contemplated that the cavity in the bone that is prepared to receive the second anchoring element 200 may leave a residual, upstanding core of bone (not shown) such that the third surface 240 will at least partially engage the upstanding core so as to provide additional initial stability and an additional surface for osseointegration.

Still referring to FIGS. 4 to 6, the first, second and third surfaces 206, 220, 240 may be interrupted by at least one non-radial slot 300 which breaches the first, second and third surfaces 206, 220, 240 and which extends away from the apical end 202 towards the fourth surface 260. The at least one slot 300 defines an at least one pointed fluke 310 extending circumferentially in the threading in direction Tᵢ from a fluke leading face 310L to a fluke trailing face 310T. The at least one fluke 310 extends generally away from the second surface 220 towards the fourth surface 260. Both the fluke leading face 310L and the fluke trailing face 310T extend away from the second surface 220 towards the fourth surface 260.

The fluke leading face 310L defines an outer leading edge 312o as it meets the first surface 206, and an inner leading edge 312i as it meets the second surface 220, so that the fluke leading face 310L extends between the outer leading edge 312o and the inner leading edge 312i. Similarly, the fluke trailing face 310T defines an outer trailing edge 314o as it meets the first surface 206 and an inner trailing edge 314i as it meets the second surface 220, so that the fluke trailing face 310T extends between the outer trailing edge 314o and the inner trailing edge 314i.

The fluke leading face 310L may be angled at a leading angle λ relative to a tangent T_{λ} to the first surface 206 at the outer leading edge 312o, while the fluke trailing face 310T may be angled at a trailing angle θ to a tangent T_{θ} to the first surface 206 at the outer trailing edge 314o. Both the leading angle λ and the trailing angle θ may be constant, or may vary along the axial extent E of the slot 310. Preferably, the leading angle λ may be acute, while the trailing angle θ may be obtuse. A normal v_{λ} to the fluke leading face 310L at the outer leading edge 312o may be directed generally radially inwardly towards the longitudinal axis ζ. Thus, in the presently discussed embodiment, the outer leading edge 312o may be referred to as an acute leading edge.

Directing attention now to FIG. 4 and, particularly to FIG. 6, the fourth surface 260 may include at least one tub 262. The at least one tub 262 may be defined by a generally apically facing tub floor 264. The tub floor 264 may be bordered by the third surface 240 and by an upstanding sidewall 266 which may extend generally apically away from the tub floor 264 so as to terminate in a generally apically-facing top surface portion 268. The upstanding sidewall 266 meets the top surface portion 268 at an upper surface edge 270. The at least one tub 262 may communicate with, and open to, the first surface 206 through the at least one slot 300.

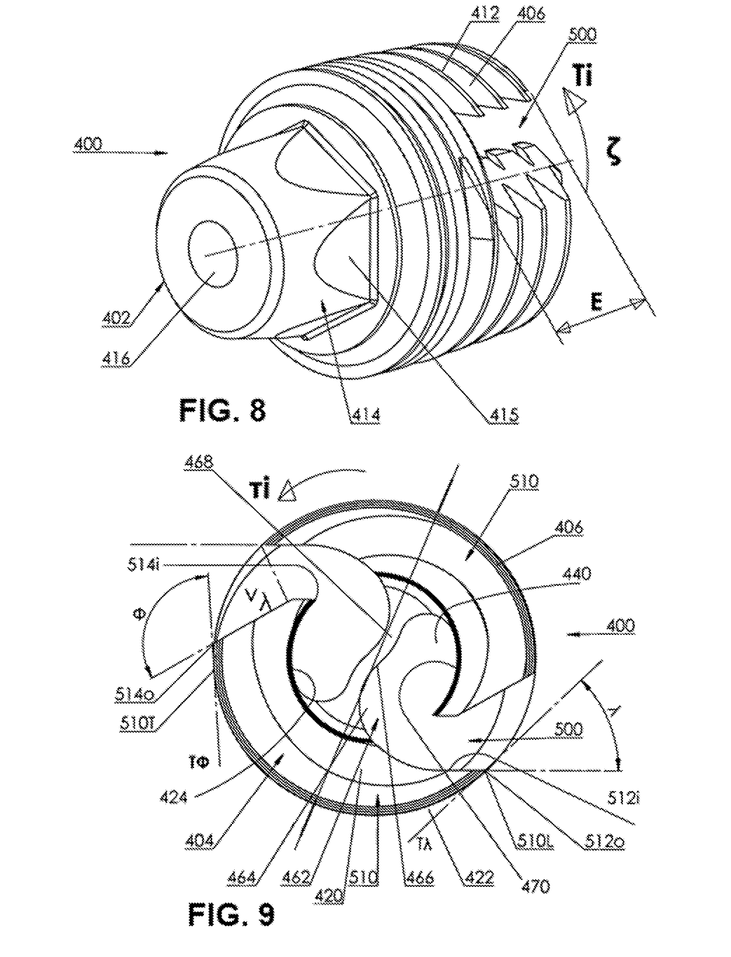

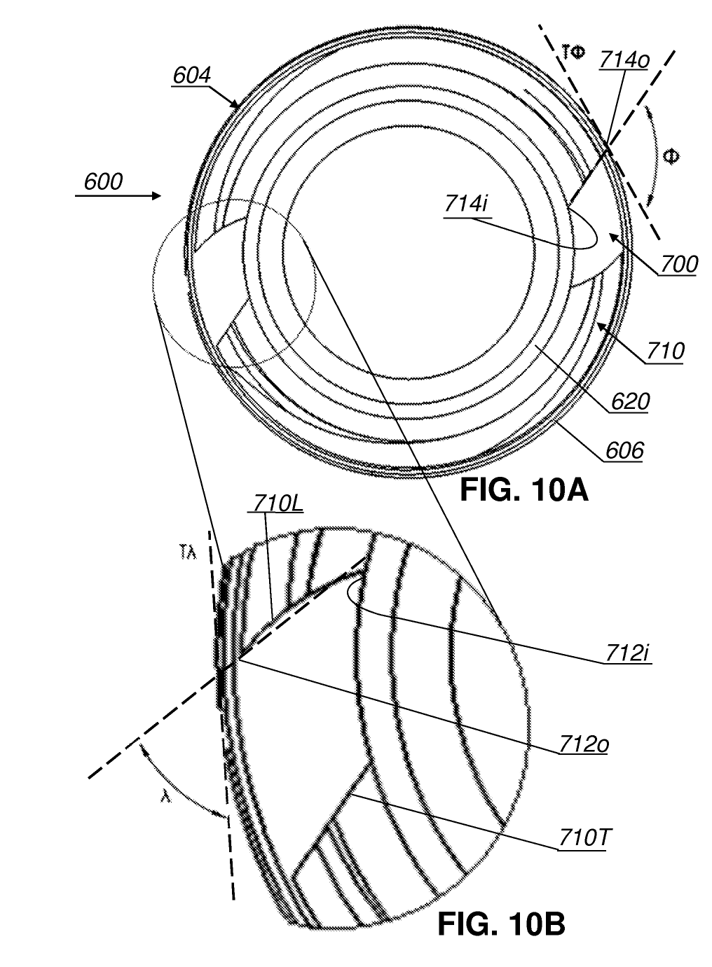

FIGS. 7 through 9 schematically illustrate a third exemplary embodiment of an anchoring element 400 that likewise illustrates the principles and teachings of the present disclosure. The third anchoring element 400 includes many features that are similar to those of the first anchoring element 100 illustrated by FIGS. 1 through 3 and to those of the second anchoring element 200 illustrated be FIGS. 4 through 6. Similar features for the third anchoring element 400 have been given reference numerals that are similar to the reference numerals used for the first anchoring element 100 increased by 300. For convenience in description, the third anchoring element 400 will be described with reference to a distal end 402 and an apical end 404. The apical end 404 is shown in FIG. 9 (as the end to the lower left of the drawing), and is the end that is embedded to the greatest depth within the bone. The distal end 402 may be best seen in FIG. 8 (as the end to the lower left of the drawing), and is the end that may be exposed when the third anchoring element 400 is embedded within the bone, as well as the end to which an attachment (not shown) may be connected to the third anchoring element 400 either integrally therewith and/or removably therefrom. The third anchoring element 400 extends from the distal end 402 to the apical end 404 along the longitudinal axis defining a circumferential threading in direction Tᵢ.

The third anchoring element 400 includes a first surface 406 that is a generally cylindrical exterior surface of the anchoring element, as an external wall. Limitations related to the term “generally cylindrical” as have been used above also apply to the third anchoring element 400. At least a portion of the first surface 406 of the third anchoring element 400 may include a peripheral first external thread 412 having a pitch. The first external thread 412 may be of any one of a variety of forms known or discovered to be effective for embedding the anchoring element within the bone. The first external thread 412 may include self-threading (thread cutting) structures or other elements or components that aid in the embedding of the third anchoring element 400 into bone, or that promote osseointegration.

As may be best seen in FIG. 8, the third anchoring element 400 may include an abutment surface 414 disposed toward the distal end of the first surface 406.

The abutment surface 414 may be of any one of a variety of known or discovered forms that permit attachment to the third anchoring element 400. In this embodiment, the abutment surface 414 is in the form of a frusto-conical pyramid having flats 415 formed on its flukes. The flats 415 formed upon the abutment surface 414 may provide wrenching surfaces. If the anchoring element is used to support a dental prosthesis, a prosthetic tooth may be directly coupled to the abutment surface 414 such as by a cement of any suitable type and/or other suitable adhesives. Alternatively, the abutment surface 414 may further include a locating recess 416 and an internal anchoring thread (not shown) to receive a device (not shown) that may be coupled to the third anchoring element 400 by a screw (not shown).

The third anchoring element 400 includes an annular second surface 420 disposed toward the apical end 404 of the first surface 406 and joined thereto along an outer circumference 422 of the second surface 420. As may be seen in FIGS. 7 and 9, the third anchoring element 400 includes a peripheral third surface 440, as an internal wall, concentric with the first surface 406 and joined to the second surface 420 along an inner circumference 424 of the second surface 420. The third surface 440 may extend away from the apical end 404 or from the second surface 420 towards an inner fourth surface 460. While in FIG. 7 it may appear that the third surface 440 may be provided with corrugations (or wavy structure), at least a portion of the third surface 440 may include a third internal feature 442 which may be of any one of a variety of forms known or discovered to be effective for embedding the anchoring element 400 into bone, such as screw threads and/or other structures such as, but not limited to, shoulders, tapered portions, rings, ridges, corrugations and the like (not shown), all of which are intended to aid in the embedding of the third anchoring element 400 into bone, or to promote osseointegration. The first surface 406 together with the third surface 440 may define an annular wall around a hollow central portion and around the longitudinal axis ζ.

It is contemplated that the cavity in the bone that is prepared to receive the third anchoring element 400 may leave a residual, upstanding core of bone (not shown) such that the third surface 440 will at least partially engage the upstanding core to provide additional initial stability and an additional surface for osseointegration.

Referring again to FIGS. 7 to 9, the first, second and third surfaces 406, 420, 440 may be interrupted by at least one non-radial slot 500 breaching the first, second and third surfaces 406, 420, 440 and extending away from the apical end 402 towards the fourth surface 460. The at least one slot 500 defines an at least one pointed fluke 510 which extends circumferentially in the threading in direction Tᵢ from a fluke leading face 510L to a fluke trailing face 510T. The at least one fluke 510 extends generally away from the second surface 420 towards the fourth surface 460. Both the fluke leading face 510L and the fluke trailing face 510T extend away from the second surface 420 towards the fourth surface 460.

The fluke leading face 510L defines an outer leading edge 512o as it meets the first surface 406 and an inner leading edge 512i as it meets the second surface 420, so that the fluke leading face 510L extends between the outer leading edge 512o and the inner leading edge 512i. Similarly, the fluke trailing face 510T defines an outer trailing edge 514o as it meets the first surface 406 and an inner trailing edge 514i as it meets the second surface 420, so that the fluke trailing face 510T extends between the outer trailing edge 514o and the inner trailing edge 514i.

The fluke leading face 510L may be angled at a leading angle λ relative to a tangent T_{λ} to the second surface 420 at the inner leading edge 512i, while the fluke trailing face 510T may be angled at a trailing angle θ to a tangent T_{θ} to the second surface 420 at the inner trailing edge 514i. Both the leading angle and the trailing angle θ may be constant, or may vary along the axial extent E of the slot 510. Preferably, the leading angle λ may be acute, while the trailing angle θ may be obtuse. A normal v_{λ} to the fluke leading face 510L at the outer leading edge 512o may be directed generally radially in a direction away from the longitudinal axis ζ. Thus, in the presently discussed embodiment, the inner leading edge 512i may be referred to as an acute leading edge.

Directing attention now to FIG. 7 and also particularly to FIG. 9, the fourth surface 460 may include at least one tub 462. The at least one tub 462 may be defined by a generally apically facing tub floor 464. The tub floor 464 may be bordered by the third surface 440 and by an upstanding sidewall 466 which may extend generally apically away from the tub floor 464 so as to terminate in a generally apically-facing top surface portion 468. The upstanding sidewall 466 meets the top surface portion 468 at an upper surface edge 470. The at least one tub 462 may communicate with, and open to, the first surface 406 through the at least one slot 500.

Returning now to the present disclosure in general, during the anchoring operation or procedure, it is contemplated that the inner fourth surfaces 160, 260, 460 of the first, second, and third anchoring elements 100, 200, 400 (which, for convenience reasons, will be collectively referred to herein after as “anchoring elements”) may come into contact with an upper upstanding top surface (not shown) of the upstanding core (not shown). Initially, contact and/or engagement of the upper upstanding top surface is made by the top surface portions 268, 468 of the anchoring elements. As such initial contact is made, the upper surface edges 270, 470 may trim and/or root and/or cut away bone chips and/or tissue remnants (not shown) so as to prepare the upper upstanding top surfaces for abutment with the top surface portions 268, 468.

Bone chips and/or tissue remnants, which may be trimmed, cut and/or rooted by the upper surface edges 270, 470, may accumulate in the at least one tubs 262, 462 to assist in enhancing osseointegration of the anchoring elements. It is further contemplated that following the embedding of the anchoring elements in the bone, the cut, rooted and/or trimmed upstanding core may provide better support, enhanced stability, and/or may provide better resistance to any bending of the anchoring elements embedded within the bone.

Optionally, the normal v_{λ} to the fluke leading face 310L at the outer leading edge 312o of the second anchoring element 200, which may be directed generally radially inwardly towards the longitudinal axis ζ, may define an acute external cutting edge that may assist in the trimming and/or rooting surrounding the bone at an anchoring site. Alternatively, the normal v_{λ} to the fluke leading face 510L at the inner leading edge 512i of the third anchoring element 400, which may be directed generally radially outwardly away from the longitudinal axis ζ, may define an acute internal cutting edge that may assist in the trimming and/or rooting the upstanding core at the anchoring site.

It is further contemplated that, with the second anchoring element 200 and/or with the third anchoring element 400, during anchoring, little or no predrilling, particularly with trephine drills, may be required, as the acute lead angle of the acute leading edge 312o, 512i of the at least one flukes 310, 510 for placing an anchoring element intended to receive an attachment to the bone may cut through any bone that is left between voids remaining after extraction of the molar roots. Moreover, it is further contemplated that bone chips and/or tissue remnants that were cut and/or rooted and/or trimmed during implantation, may escape through the slots 300, 500, to reduce pressure on healthy bone, as well as potentially to assist in the osseointegration and to prevent any turning or rotation after osseointegration.

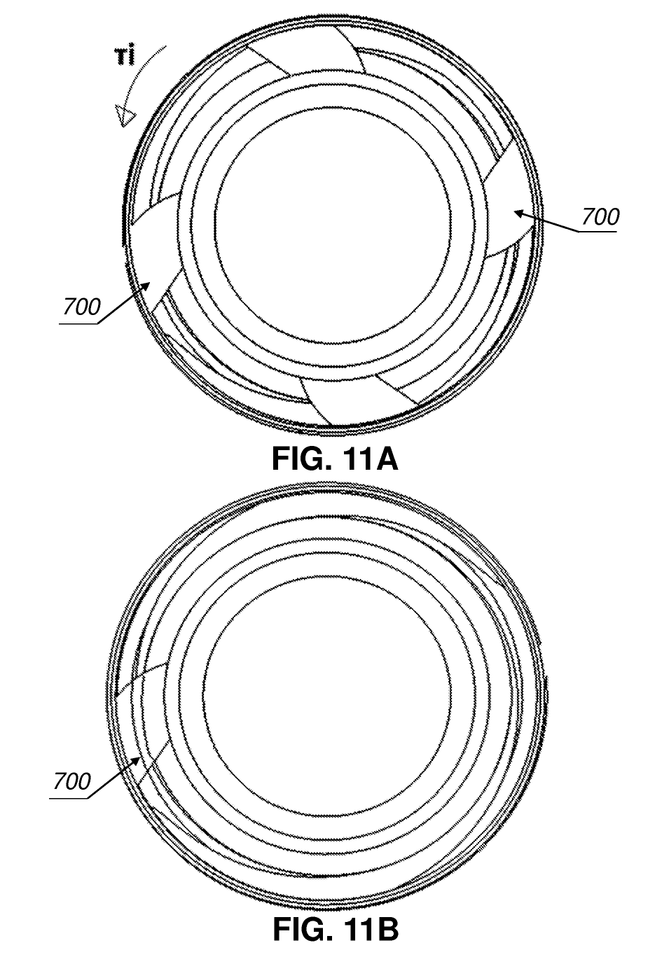

FIG. 10A schematically illustrates a bottom view of a further exemplary embodiment of a fourth anchoring element 600, and FIG. 10B shows an enlarged segment of the same. Similar features for the fourth anchoring element 600 have been given reference numerals that are similar to the reference numerals used for the third anchoring element 400 (shown in FIGS. 7-9) increased by 200. The fourth anchoring element 600 includes a first surface 606 that is a generally cylindrical exterior surface of the anchoring element 600, as an external wall, with at least a portion of the first surface 606 having circumferential threading in direction Tᵢ.

The fourth anchoring element 600 further includes an annular second surface 620 disposed toward the apical end 604 of the first surface 606. The first surface 606 may be breached by at least one non-radial slot 700 at an apical end 604, that defines an at least one pointed fluke 710 extending circumferentially in the threading (in direction Tᵢ) from a fluke leading face 710L to a fluke trailing face 710T. The fluke trailing face 710T defines an outer trailing edge 714o as it meets the first surface 606 and an inner trailing edge 714i as it meets the second surface 620, so that the fluke trailing face 710T extends between the outer trailing edge 714o and the inner trailing edge 714i. The fluke trailing face 710T may be angled at a trailing angle θ to a tangent T_{θ}.

It should be noted that the fourth anchoring element 600 is similar to the second and third anchoring elements 200, 400 (shown in FIGS. 4-9) as in all anchoring elements the fluke leading face is not parallel to the fluke trailing face, while the fourth anchoring element 600 has an additional feature of a curved fluke leading face 710L. The curved fluke leading face 710L may provide enhanced support while cutting through the bone. The fluke leading face 710L defines an outer leading edge 712o as it meets the first surface 606 and an inner leading edge 712i as it meets the second surface 620, so that the curved fluke leading face 710L extends between the outer leading edge 712o and the inner leading edge 712i. By normalizing the curved leading face 710L into a straight line (with multiple tangents), a leading angle λ is created to a tangent T_{λ}. Preferably, the leading angle λ may be acute (e.g. in the range of 30°-55°), while the trailing angle θ may be obtuse. More preferably, the ratio between the leading angle λ and trailing angle θ is in the range of λ/θ≈0.2-0.4.

FIG. 11A schematically illustrates a bottom view of a further exemplary embodiment of the fourth anchoring element having four slots, and FIG. 11B schematically illustrates a bottom view of a further exemplary embodiment of the fourth anchoring element having only one slot. Preferably, the anchoring element has three slots with each slot having a curved fluke leading face.

An additional requirement of such anchoring elements is that they will be provided in a variety of diameters as different patients (with different jaw structures) may require different sizes of prosthetics. Moreover, the physician can identify the position of the posterior superior and/or inferior alveolar nerves (supplying molars with sensory nerve branches) in an x-ray computed tomography (CT) of the molar region of the jaw, so that a required length of the anchoring element may be chosen in order to prevent hitting these nerves. By having the maximal possible length of the anchoring element, the anchoring element may be anchored deeper into the bone and thus achieve increased stability. In the following, further embodiments of the anchoring element are described having a similar external structure with a circumferential threading and slots (with non-parallel fluke leading and trailing faces), while having a different inner structure in order to allow using anchoring elements of different lengths or diameters.

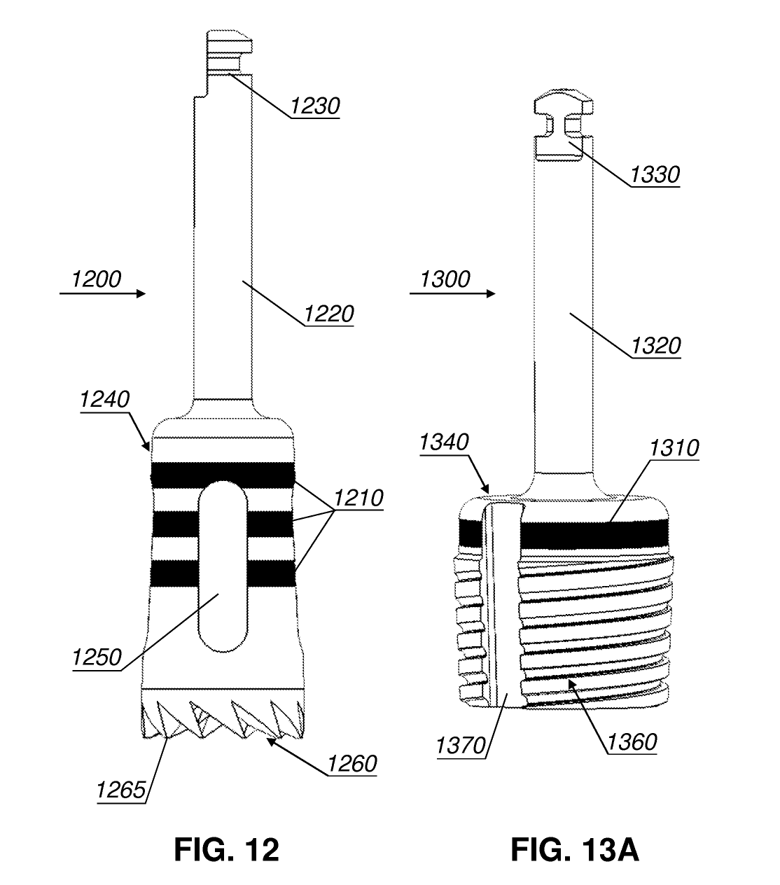

FIG. 12 schematically illustrates a frontal view of a drilling tool 1200. The drilling tool 1200 is configured to allow drilling at the cavity void of the molar roots (prior to embedding the anchoring element at the jaw bone) in order to lengthen this void to a length corresponding to the required length for the anchoring element. The drilling tool 1200 has a cylindrical body 1220 with a rotary connection element 1230 at a distal end, and an annular drilling element 1240 at a proximal end. The rotary connection element 1230 (at the distal end of the cylindrical body 1220), may connect to an external rotating tool (not shown) in order to rotate the entire drilling tool 1200. Such external rotating tools may be operated manually (for instance using a hand ratchet or a torque ratchet) or operated with a motor (as in typical dental motorized tools).

The annular drilling element 1240 (at the proximal end of the cylindrical body 1220), is a hollow structure with at least one window 1250, a cutting section 1260, and a plurality of indexing lines 1210. The at least one window 1250 may provide a path for evacuating material (such as cut bone segments) from the inner space of the annular drilling element 1240 during drilling, in order to avoid blocking the progression of the drilling tool 1200. The cutting section 1260 has a plurality of cutting teeth 1265 (similarly to a hole saw drill) that may cut the jaw bone around the inter-radicular septum (the bone between the roots) and deepen the void of the molar roots with a cylindrical section (not shown) to a required depth. The inner and/or outer diameters of the cutting section 1260 may be adjusted to correspond to the required diameters of the anchoring element, so that for each diameter of the anchoring element a specific drilling tool 1200 may be used.

The required drilling depth of this cylindrical section may be controlled by the physician using the plurality of indexing lines 1210. Once the a required length of the anchoring element is chosen (based on the CT scan), the physician may then operate the drilling tool 1200 to cylindrically deepen the void of the molar roots for that required length by stopping the drilling operation when the appropriate indexing line 1210 aligns with the gingiva. Finally, the drilling leaves a cylindrical grove (not shown) with bone on the inside (as the upstanding core) and on the outside of the cavity groove. In this way, a single drilling tool 1200 may be used for different length configurations of the anchoring element (thus reducing the number of operating tools).

For example, a first indexing line 1210 marks a length of 6 mm (measured from the edge of the cutting section 1260), the second indexing line 1210 marks a length of 8 mm, and a third indexing line 1210 marks a length of 10 mm. If a physician chooses an anchoring element for a length of 8 mm, then the required cylindrical groove may be created by stopping the drilling operation when the second indexing line 1210 aligns with the gingiva.

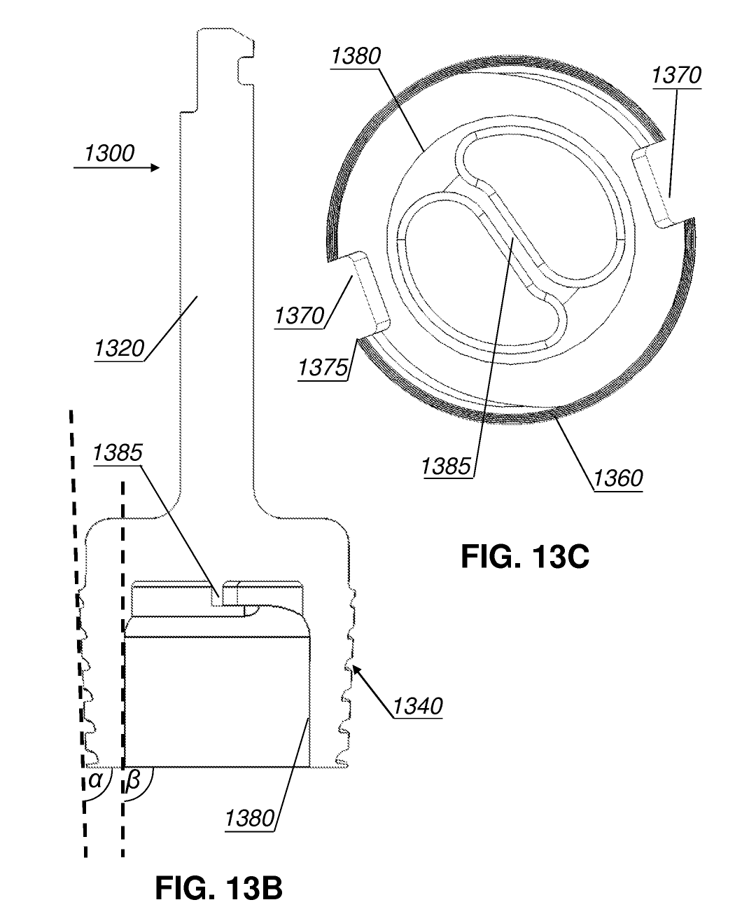

Referring now to FIGS. 13A-13C, FIG. 13A schematically illustrates a milling tool 1300. FIG. 13B schematically illustrates a cross-sectional view of the milling tool 1300, and FIG. 13C schematically illustrates a bottom view of the milling tool 1300. The milling tool 1300 is configured to allow milling the jaw bone surrounding the cylindrical groove (not shown) created by the drilling tool 1200, in order to create a thread shape in the bone to fit the shape of the anchoring element (similarly to a screw tap). Similar features for the milling tool 1300 have been given reference numerals that are similar to the reference numerals used for the drilling tool 1200.

The milling tool 1300 has a cylindrical body 1320 with a rotary connection element 1330 at a distal end, and an annular milling element 1340 at a proximal end. The rotary connection element 1330 (at the distal end of the cylindrical body 1320) is similar to the rotary connection element 1230 of the drilling tool 1200 (shown in FIG. 12), and may also connect to an external rotating tool (not shown) in order to rotate the entire milling tool 1300. Such external rotating tools may be operated manually (for instance using a hand ratchet or a torque ratchet) or operated with a motor (as in typical dental motorized tools).

The annular milling element 1340 (at the proximal end of the cylindrical body 1320) is a hollow conical structure with a threading 1360 on the external surface of the annular milling element 1340, and an additional conical structure on the inner surface (further shown in FIGS. 13B-13C). The annular milling element 1340 further has an indexing line 1310, and at least one indentation 1370 in the external surface (breaching the threading 1360). The at least one indentation 1370 has two main purposes, the first purpose is to provide a path for evacuating bone material (e.g. bone chips) that may accumulate during milling, in order to avoid blocking the progression of the milling tool 1300 (similarly to the at least one window 1250, shown in FIG. 12). The second purpose of the at least one indentation 1370 is to create multiple threading starts 1375 (shown in FIG. 13C), due to the breaching of the threading 1360, with each threading start 1375 initiating cutting a different segment of the jaw bone during milling.

The required milling depth may be controlled by the physician using the indexing line 1310, corresponding to the first indexing line 1210 (nearest to the proximal end of the drilling tool 1200, shown in FIG. 12). Once the cylindrical groove (not shown) is created with the drilling tool 12, the physician may then operate the milling tool 1300 to create a conical thread shape in the bone on the outside of this groove to the required length, by stopping the milling operation when the indexing line 1310 aligns with the gingiva. It should be noted that the milling tool 1300 has only a single indexing line 1310 (unlike the drilling tool 1200, shown in FIG. 12), in order to have a single milling tool 1300 that may be used with anchoring elements of different lengths due to the conical shape of the annular milling element 1340.

For example, a first indexing line 1210 marks a length of 6 mm (measured from the proximal edge of the drilling tool 1200, shown in FIG. 12), the second indexing line 1210 marks a length of 8 mm, and a third indexing line 1210 marks a length of 10 mm. If a physician chooses an anchoring element for a length of 8 mm, then once the required cylindrical groove is created by the drilling operation, the milling operation may shape the bone for the length of 6 mm when the indexing line 1310 (corresponding to the first indexing line 1210) aligns with the gingiva. In this way, the groove in the jaw bone (not shown) must have a conical shape for the top portion of 6 mm, and a cylindrical shape for the bottom portion (only drilled and not milled) of 2 mm.

The conical structure on the inner surface 1380 of the annular milling element 1340 further has an upper surface edge 1385 (at the apex of the cone) that may trim and/or root and/or cut away bone chips and/or tissue remnants (not shown) so as to prepare the upper upstanding top surfaces for abutment with the anchoring element at a later stage. It should be noted that during the milling operation, the milling tool 1300 engages the jaw bone with the threading 1360 at the external surface of the annular milling element 1340 at an inclination angle α that is different from the inclination angle β of the inner surface 1380, so that the thickness may change along the length of the annular milling element 1340.

The inner and/or outer diameters of the annular milling element 1340 may be adjusted to correspond to the required diameters of the anchoring element, similarly to the diameters of the drilling tool 1200 (shown in FIG. 12). So that for each diameter of the anchoring element a specific milling tool 1300 may be used. In this way, a single milling tool 1300 may be used for different length configurations of the anchoring element (thus further reducing the number of operating tools).

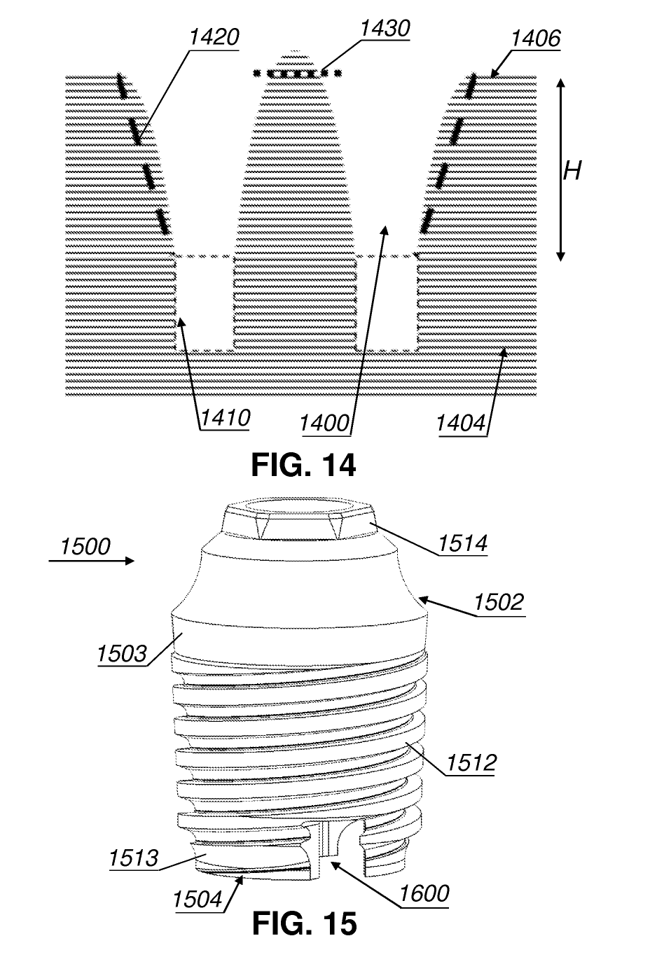

FIG. 14 schematically illustrates a cross-sectional view of the groove 1400 created in the bone 1404 after the drilling and milling procedures. The drilling tool 1200 (shown in FIG. 12) may create a cylindrical void 1410, corresponding to the required length of the anchoring element. The milling tool 1300 (shown in FIGS. 13A-13C) may create a conical thread shape in the bone surrounding the cylindrical void 1410, with the threading 1360 of the milling tool 1300 cutting the bone outside the groove 1400 to be in a conical shape 1420. The upper surface edge 1385 of the milling tool 1300 may cut the upstanding core 1430 to align with the gingiva 1406 so that the anchoring element (not shown) may fit to this groove 1400. It should be noted that in this configuration, the groove 1400 has a cylindrical portion 1410, and also a conical portion 1420 with a height marked “H” corresponding to the height of the annular milling element 1340. By providing an anchoring element having an inner structure with both a cylindrical section and a conical section, an increased stability of the anchoring element in the groove 1400 may be achieved.

In case that the anchoring element had only a conical shape, then a different milling tool will be required for each length since each length makes a different cone shape (due to a different inclination, unlike with different lengths in a cylinder).

In a further embodiment (not shown), the required length of the anchoring element corresponds to a minimal length of the groove (i.e. the height of the annular milling element) and thus the drilling operation may stop at this minimal length without lengthening the groove and creating a cylindrical void. In this embodiment, the anchoring element may only have a conical inner structure.

FIG. 15 schematically illustrates a further exemplary embodiment of a fifth anchoring element 1500. Similar features for the fifth anchoring element 1500 have been given reference numerals that are similar to the reference numerals used for the third anchoring element 400. The fifth anchoring element 1500 has an abutment surface 1514 and a contact section 1503 at a distal end 1502. The fifth anchoring element 1500 further has a first external threading 1512 at the conical section of the fifth anchoring element 1500, and a second external threading 1513 at the cylindrical section of the fifth anchoring element 1500 at a proximal end 1504. The proximal end 1504 may be breached, in the cylindrical section and/or in the conical section, by at least one non-radial slot 1600 (similarly to the at least one slot 700 of the fourth anchoring element 600, shown in FIGS. 10A-11B).

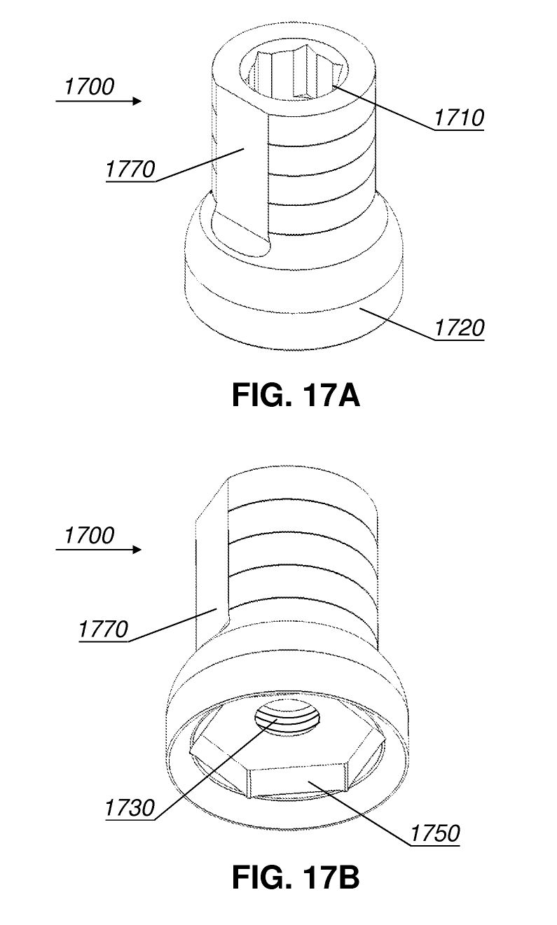

The abutment surface 1514 (e.g. with a hexagonal shape) may engage an abutment (shown in FIGS. 17A-17B) at a later stage, and the contact section 1503 may be aligned to contact cortical bone once the fifth anchoring element 1500 is fully inserted into the bone, so that only the portion above the contact section 1503 may be exposed (i.e. not contacting the jaw bone or gums). The second external threading 1513 may have a different pitch than the first external threading 1512 (e.g. a pitch smaller by 5%), such that the second external threading 1513 may function as a compression structure for compressing the soft tissue (at the cylindrical void 1410, shown in FIG. 14) surrounding the cylindrical section during insertion of the fifth anchoring element 1500.

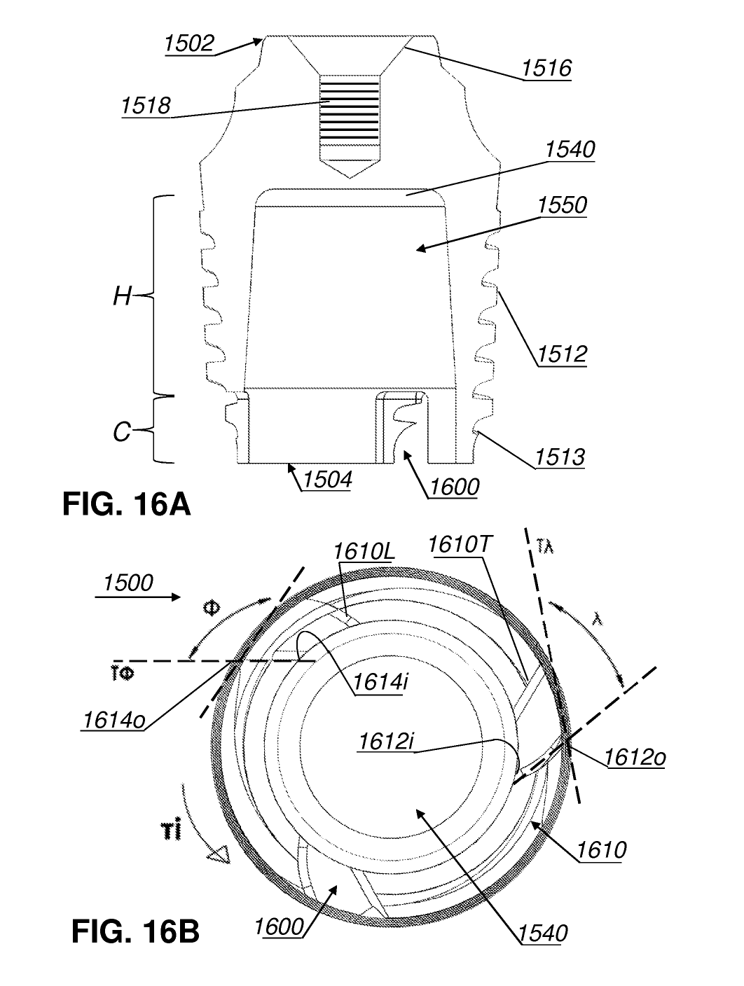

FIG. 16A schematically illustrates a cross-sectional view of the fifth anchoring element 1500 (shown in FIG. 15). A locating recess 1516 with internal threading 1518 is positioned at the distal end 1502 and may accommodate a screw (not shown) in order to couple the fifth anchoring element 1500 to an abutment (further described in the following).

The first external threading 1512 is in the conical section (marked as “H”), and the second external threading 1513 is in the cylindrical section (marked as “C”) at the proximal end 1504 with at least one slot 1600. The cylindrical section (marked “C”) may have a constant thickness while the thickness of the conical section (marked “H”) may vary due to its conical shape. The at least one slot 1600 may cut, collect and compress bone chips into an inner chamber 1550 to assist in enhancing osseointegration of the upstanding core. The inner chamber has an upper surface 1540 that may at least partially engage the upstanding core to provide additional initial stability and an additional surface for osseointegration.

It should be noted that while the length of the cylindrical section (marked “C”) may change (according to the requirements of individual patients), the length of the conical section (marked “H”) may remain constant for all possible configurations of the fifth anchoring element 1500. In this way for each diameter of the fifth anchoring element 1500, only a single drilling tool 1200 and a single milling tool 1300 (shown in FIGS. 12-13) as they do not differ with a different length, therefore reducing the number of required tools.

In a further embodiment (not shown), the walls of the fifth anchoring element are not breached by slots, however in this embodiment the anchoring element may still have a conical portion and also a cylindrical portion as described above.

FIG. 16B schematically illustrates a bottom view of the fifth anchoring element 1500 (shown in FIG. 15). The at least one slot 1600 defines an at least one pointed fluke 1610 extending circumferentially in the threading (in direction Tᵢ) from a fluke leading face 1610L to a fluke trailing face 1610T. The fluke trailing face 1610T defines an outer trailing edge 1614o and an inner trailing edge 1614i (similarly to the forth anchoring element 600, shown in FIGS. 10A-11B), so that the fluke trailing face 1610T extends between the outer trailing edge 1614o and the inner trailing edge 1614i. The fluke trailing face 1610T may be angled at a trailing angle θ to a tangent T_{θ}.

A curved fluke leading face 1610L may provide enhanced support while cutting through the bone. The fluke leading face 1610L defines an outer leading edge 1612o and an inner leading edge 1612i, so that the curved fluke leading face 1610L extends between the outer leading edge 1612o and the inner leading edge 1612i. By normalizing the curved leading face 1610L into a straight line (with multiple tangents), a leading angle λ is created to a tangent T_{λ}. Preferably, the leading angle λ may be acute (e.g. in the range of 30°-55°), while the trailing angle θ may be obtuse. More preferably, the ratio between the leading angle λ and trailing angle θ is in the range of λ/θ≈0.2-0.4.

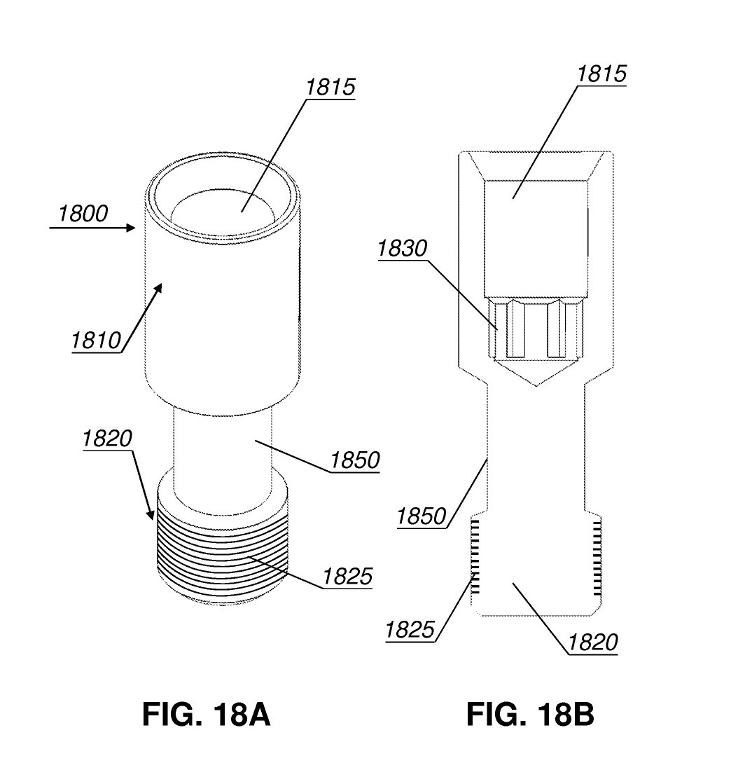

FIG. 17A schematically illustrates an isometric view of an abutment 1700, and FIG. 17B schematically illustrates a bottom isometric view of the same. The abutment 1700 is a hollow structure configured to allow connection to the fifth anchoring element 1500 (shown in FIG. 15) with a dedicated screw (shown in FIGS. 18A-18B), and also to allow coupling the abutment 1700 to a dental prosthesis at a later stage.

The abutment 1700 has a top section 1710 having an internal shape configured to allow rotation by an external rotation key (not shown), with an opening through which the screw (shown in FIGS. 18A-18B) may be inserted. The abutment 1700 further has a bottom section 1720 with an internal surface 1750 having a shape corresponding to the abutment surface 1514 (e.g. hexagonal shape) of the fifth anchoring element 1500 (shown in FIG. 15). A bottom opening 1730 (with internal threading) in the bottom section 1720 may provide a passage for the screw to partially exit the abutment 1700 and engage the fifth anchoring element 1500.

A flat surface 1770 on the circumference of the abutment 1700 may provide an indication on the orientation of the abutment relatively to the fifth anchoring element 1500 (shown in FIG. 15). This indication may assist the physician in positioning the abutment onto the fifth anchoring element 1500 (already implanted into the jaw bone), as the internal surface 1750 has a specific shape corresponding to the abutment surface 1514 so that the abutment cannot connect to the fifth anchoring element 1500 simply by placing the bottom section 1720 of the abutment 1700 onto the abutment surface 1514. Using the flat surface 1770, the physician may locate the proper position for coupling the abutment 1700 to the fifth anchoring element 1500. Furthermore, the flat surface 1770 may be also used as a connection surface when coupled to a dental prosthesis at a later stage.

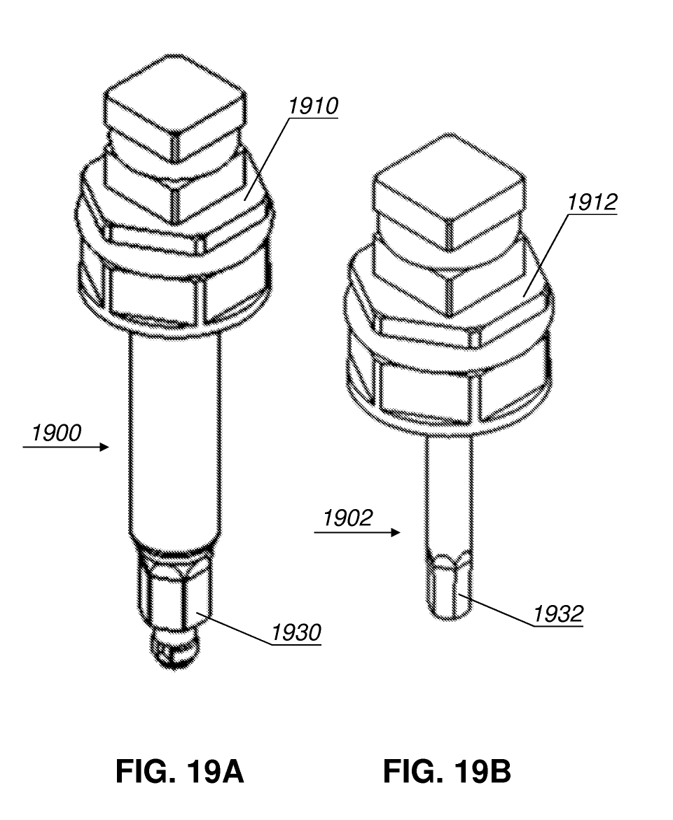

FIG. 18A schematically illustrates an isometric view of a screw 1800, and FIG. 18B schematically illustrates a cross-sectional view of the same. The screw 1800 has a top portion 1810 with a top cavity 1815, the top cavity 1815 having an internal surface 1830 with a shape configured to allow rotation with an external key (shown in FIG. 19B). The shape of the internal surface 1830 may be different from the shape of the top section 1710 of the abutment 1700 (shown in FIGS. 17A-17B) as they may be rotated using different keys (shown in FIGS. 19A-19B).

The screw 1800 further has an intermediate cylindrical body 1850 connecting the top portion 1810 of the screw 1800 to a bottom portion, with the diameter of the intermediate cylindrical body 1850 being smaller than the diameters of the top 1810 or bottom 1820 portions. The bottom portion 1820 further has external threading 1825, corresponding to the internal threading 1518 of the fifth anchoring element 1500 (shown in FIG. 15), and also corresponding to the internal threading of the bottom opening 1730 of the abutment 1700 (shown in FIG. 17B).

FIG. 19A schematically illustrates an isometric view of a first rotation key 1900. The first rotation key 1900 has a gripping section 1910 and a first rotating element 1930. The first rotating element 1930 may engage the top section 1710 of the abutment 1700 (shown in FIGS. 17A-17B) having a corresponding shape. Once the first rotating element 1930 engages the top section 1710, then the first rotation key 1900 may be rotated by rotating the gripping section 1910 with manual (e.g. a manual ratchet) or motorized (e.g. a dental motor operated ratchet) tools. If the first rotation key 1900 is rotated, then the entire abutment 1700 may be rotated as a result.

FIG. 19B schematically illustrates an isometric view of a second rotation key 1902. The second rotation key 1902 has a gripping section 1912 (similarly to the gripping section 1900 of the first rotation key 1900) and a second rotating element 1932. The second rotating element 1932 may engage the internal surface 1830 of the screw 1800 (shown in FIGS. 18A-18B) having a corresponding shape. Once the second rotating element 1932 engages the internal surface 1830, then the second rotation key 1902 may be rotated by rotating the gripping section 1912 with manual (e.g. a manual ratchet) or motorized (e.g. a dental motor operated ratchet) tools. If the second rotation key 1902 is rotated, then the entire screw 1800 may be rotated as a result.

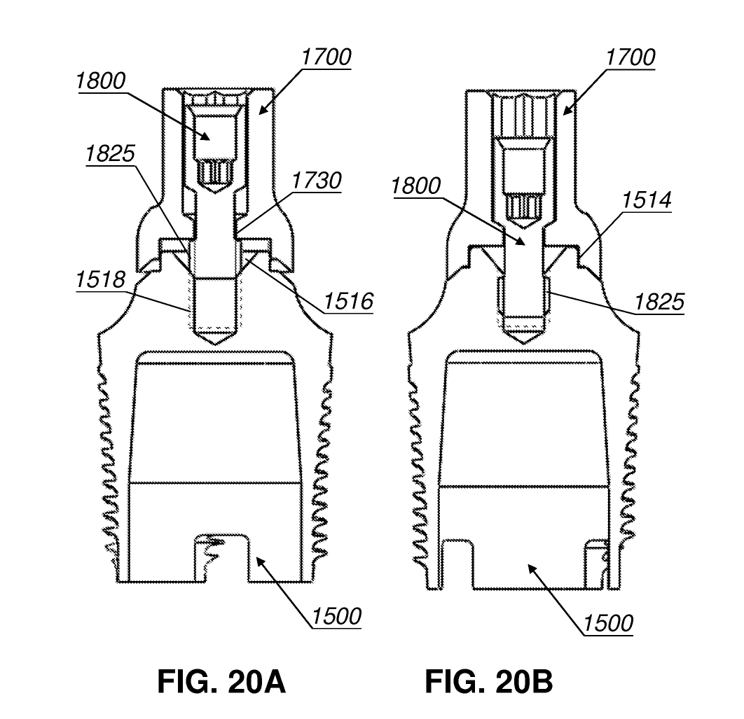

FIG. 20A schematically illustrates an assembled view of the fifth anchoring element 1500, the abutment 1700, and the screw 1800 prior to inserting the screw 1800 into the fifth anchoring element 1500. Once the screw 1800 exits through the bottom opening 1730 of the abutment 1700, the external threading 1825 of the screw 1800 may engage the internal threading 1518 of the fifth anchoring element 1500. Due to the conical shape of the locating recess 1516 of the fifth anchoring element 1500, the screw 1800 is centralized and may directly engage the internal threading 1518.

FIG. 20B schematically illustrates an assembled view of the fifth anchoring element 1500, the abutment 1700, and the screw 1800 after inserting the screw 1800 into the fifth anchoring element 1500. The abutment 1700 is coupled to the abutment surface 1514 and therefore keeps steadily onto the fifth anchoring element 1500 as it cannot rotate. Once the screw 1800 is tightened to the fifth anchoring element 1500, for instance by rotating the screw 1800 with the second rotation key 1902 (shown in FIG. 19B), then the abutment 1700 may be connected to the fifth anchoring element 1500.

Since the outer surface of the fifth anchoring element 1500 must remain sterile (to prevent contaminations to the bone), the physician may receive a kit with the abutment 1700 already assembled onto the fifth anchoring element 1500, with the screw 1800 tightened to the internal threading 1518. The physician may then pick up this assemble using the first rotation key 1900 (shown in FIG. 19A) and inserted into the predrilled groove (not shown) by rotating the first rotation key 1900.

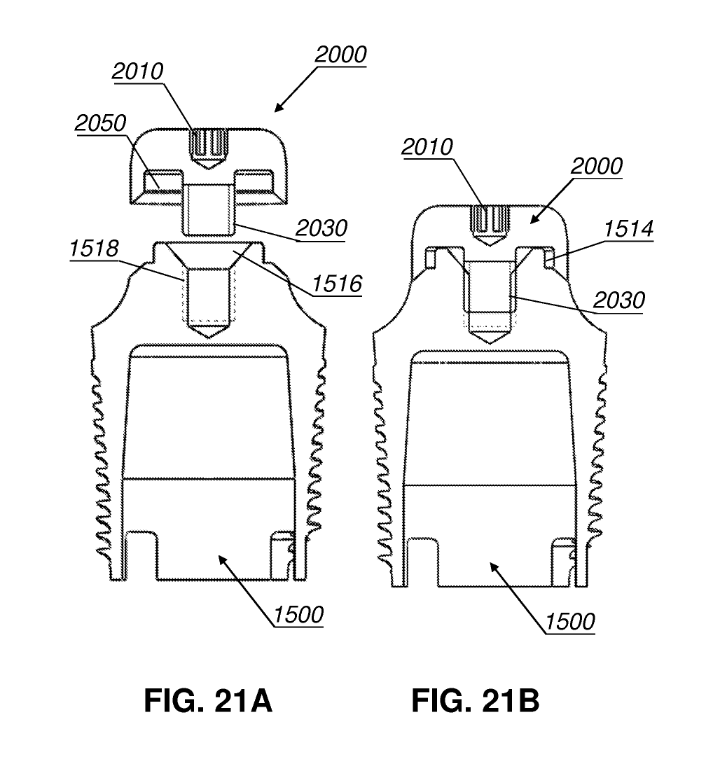

In a further embodiment, the abutment 1700 is replaced by a healing cap (shown in FIGS. 21A-21B) for a short period (e.g. three months) in order to allow osseointegration with the fifth anchoring element 1500. After this healing period, the healing cap may be removed and replaced again with the abutment 1700 so that a dental prosthesis (not shown) may be assembled onto the abutment 1700.

FIG. 21A schematically illustrates an exploded view of the fifth anchoring element 1500, and the healing cap 2000. FIG. 21B schematically illustrates an assembled view of the fifth anchoring element 1500, and the healing cap 2000.

The healing cap 2000 has a top cavity 2010 having a shape corresponding to the second rotating element 1932 of the second rotating key 1902 (shown in FIG. 19B). The healing cap 2000 further has a bottom threaded section 2030, and a symmetrical inner structure 2050 that may engage the abutment surface 1514 of the fifth anchoring element 1500 (without a specific orientation). The bottom threaded section 2030 may engage the locating recess 1516 until it contacts the internal threading 1518 of the fifth anchoring element 1500, so that by rotating the healing cap 2000 (with the second rotating key 1902) then the healing cap 2000 may connect to the fifth anchoring element 1500. Similarly the healing cap 2000 may be removed from the fifth anchoring element 1500 also using the second rotating key 1902.

All directional references (such as, but not limited to, upper, lower, upward, downward, left, right, leftward, rightward, top, bottom, above, below, vertical, horizontal, clockwise, and counterclockwise, tangential, axial and/or radial, or any other directional and/or similar references) are only used for identification purposes to aid the reader's understanding of the embodiments of the present disclosure, and may not create any limitations, particularly as to the position, orientation, or use unless specifically set forth in the claims. Similarly, joinder references (such as, but not limited to, attached, coupled, connected, and the like) are to be construed broadly and may include intermediate members between a connection of elements and relative movement between elements. As such, joinder references may not necessarily infer that two elements are directly connected and in fixed relation to each other.

In some instances, components are described with reference to “ends” having a particular characteristic and/or being connected with another part. However, those skilled in the art will recognize that the present disclosure is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like.

Additionally, all numerical terms, such as, but not limited to, “first”, “second”, “third”, or any other ordinary and/or numerical terms, should also be taken only as identifiers, to assist the reader's understanding of the various embodiments, variations and/or modifications of the present disclosure, and may not create any limitations, particularly as to the order, or preference, of any embodiment, variation and/or modification relative to, or over, another embodiment, variation and/or modification.

While certain exemplary aspects and/or embodiments have been broadly described and/or schematically illustrated in the accompanying drawings, it is to be understood that such aspects and/or embodiments are merely illustrative of, and not restrictive on, the broad present disclosure. Furthermore, those of skill in the art may recognize that the present disclosure may not be limited to the specific constructions and arrangements shown and described, since various other modifications, permutations, additions and sub-combinations may occur to those ordinarily skilled in the art, without detracting from the scope of the present disclosure. It is to be understood that individual features shown or described for one embodiment may be combined with individual features shown or described for another embodiment. Furthermore, it is to be understood some features may have been shown or described to illustrate the use of the present disclosure in the context of functional anchoring elements and such features may be omitted within the scope of the present disclosure.

1. An anchoring element for use in bone, comprising:
an external wall having externally threaded peripheral surface facilitating the embedding of said anchoring element within the bone;
an internal wall having an internal peripheral surface that, taken together with said externally threaded peripheral surface, define an annular wall around a hollow central portion and around a longitudinal axis ζ; and
at least one non-radial slot passing through said externally threaded peripheral surface of said external wall, said annular wall, and said internal peripheral surface of said internal wall, such that at least one pointed fluke is defined at a juncture of said non-radial slot and said outer peripheral surface for cutting the bone and directing bone fragments into said hollow central portion,
wherein said at least one pointed fluke extends from a fluke leading face to a fluke trailing face, and wherein said fluke leading face is skewed relatively to said fluke trailing face.

2. The anchoring element of claim 1, wherein threads of said externally threaded outer peripheral surface are self-threading.

3. The anchoring element of claim 1, wherein said internal peripheral surface of said anchoring element is threaded.

4. The anchoring element of claim 1, wherein said external wall has a conical shape.

5. The anchoring element of claim 4, wherein said hollow central portion has a conical shape.

6. The anchoring element of claim 5, wherein said hollow central portion further comprises a cylindrical portion.

7. The anchoring element of claim 6, wherein said external threading on the conical portion has a different pitch than the pitch of the external threading of the cylindrical section.

8. The anchoring element of claim 1, wherein said at least one pointed fluke curves circumferentially and radially inwardly.

9. The anchoring element of claim 8, wherein said fluke leading face defines a fluke outer leading edge as said fluke leading face meets said outer peripheral surface, and a fluke inner leading edge as said fluke leading face meets said inner peripheral surface, while said fluke trailing face defines a fluke outer trailing edge as said fluke trailing edge meets said outer peripheral surface and a fluke inner trailing edge as said fluke trailing face meets said inner peripheral surface.

10. The anchoring element of claim 9, wherein said fluke leading face extends between said fluke outer leading edge and said fluke inner leading edge, and wherein said fluke trailing face extends between said fluke outer trailing edge and said fluke inner trailing edge.

11. The anchoring element of claim 10, wherein said fluke leading face is angled at a leading angle λ relative to a tangent T_{λ} with respect to said outer peripheral surface at said fluke outer leading edge.

12. The anchoring element of claim 11, wherein said fluke trailing face is angled at a trailing angle θ relative to a tangent T_{θ} with respect to said outer peripheral surface at said fluke outer trailing edge.

13. The anchoring element of claim 12, wherein at least one of said leading angle λ and said trailing angle θ is constant.

14. The anchoring element of claim 12, wherein at least one of said leading angle λ and said trailing angle θ varies along an axial extent E of said at least one non-radial slot.

15. The anchoring element of claim 12, wherein said leading angle λ is acute.

16. The anchoring element of claim 15, wherein said leading angle λ is in the range between 30° and 55° degrees.

17. The anchoring element of claim 12, wherein said trailing angle θ is obtuse.

18. The anchoring element of claim 12, wherein the ratio between the leading angle λ and trailing angle θ is in the range between 0.2 and 0.4.

19. The anchoring element of claim 11, wherein a normal v_{λ} to said fluke leading face at said fluke outer leading edge is directed generally inwardly towards said longitudinal axis ζ.

20. The anchoring element of claim 11, wherein a normal v₂ to said fluke leading face at said fluke outer leading edge is directed generally outwardly away from said longitudinal axis ζ.

21. An anchoring element for use in bone, comprising:
an external wall having a conical shape with externally threaded peripheral surface facilitating the embedding of said anchoring element within the bone; and
an internal wall having an internal peripheral surface that, taken together with said externally threaded peripheral surface, define an annular wall around a conical hollow central portion;
wherein said hollow central portion further comprises a cylindrical portion.

22. The anchoring element of claim 21, wherein said external threading on the conical portion has a different pitch than the pitch of the external threading of the cylindrical section.

23. A method for placing an anchoring element into jaw bone, the method comprising:
providing the anchoring element of claim 5, further comprising a locating recess with internal threading;
providing an abutment having a hollow structure with internal threading;
providing a screw having a bottom portion with external threading corresponding to the internal threading of said abutment, and further corresponding to the internal threading of said locating recess;
providing a drilling tool having an annular drilling element with a cutting section and a plurality of indexing lines;
providing a milling tool having an annular milling element with a conical shape and external threading with an upper surface edge and a single indexing line corresponding to said plurality of indexing lines of said annular drilling element;
drilling with said cutting section of the drilling tool, to a predetermined depth until a predetermined indexing line aligns with the bone surface;
milling and creating a conical thread with said external threading of the milling tool to a predetermined depth until said single indexing line aligns with the bone surface;
trimming bone chips with said upper surface edge of said annular milling element;
rotating said anchoring element and inserting into the bone, such that the threading of the anchoring element engages the bone;
attaching said abutment to said anchoring element; and
inserting said screw to engage the internal threading of said abutment and of said anchoring element.

24. The method of claim 23, wherein said annular drilling element further has at least one window.

25. The method of claim 23, wherein said annular milling element further has at least one indentation.
